(19) United States
(12) Patent Application Publication
(10) Pub. No.: US 2025/0370906 A1
(43) Pub. Date: Dec. 4, 2025

(54) Detecting Faulty Deployments Using Weak Supervision

(71) Applicant: Datadog, Inc., New York, NY (US)

(72) Inventors: Clément Damien Acher, PARIS (FR); David Stefan Asker, New York, NY (US); Sebastien Nathan R Levy, New York, NY (US)

(21) Appl. No.: 19/081,271

(22) Filed: Mar. 17, 2025

Related U.S. Application Data
(60) Provisional application No. 63/655,354, filed on Jun. 3, 2024.

(51) Int. Cl. G06F 11/3604; G06F 8/60; G06F 11/30

(52) U.S. Cl. CPC G06F 11/3608; G06F 8/60; G06F 11/302

(57) ABSTRACT

The technology disclosed herein provides a framework for quickly detecting faulty software deployments, using a sequence of different analysis models executed at different time increments after the deployment. The analyses may include different machine learning models. Periodically, the system collects data on each deployment during the given period, and applies a set of labelling functions to generate non-binary classifications. The non-binary classifications are used to generate labels using weak supervision, and the labels are used for training a supervised machine learning model. The trained models may be used in the sequence of different analyses executed for future software deployments.

### CROSS REFERENCE TO RELATED APPLICATIONS

The present application claims the benefit of the filing date of U.S. Provisional Patent Application No. 63/655,354 filed Jun. 3, 2024, the disclosure of which is hereby incorporated herein by reference.

### BACKGROUND

Deployments are new versions of code for a service. Generally, such deployments are tracked using performance monitoring telemetry. When a new version of code is deployed, telemetry pertaining to this version is assigned a new version tag, and users can determine whether that version is faulty. The version may be faulty if, for example, it introduces new errors or defects or an increased defect rate. Typically, determining whether the new version is faulty is performed manually by comparing telemetry from the new version to some baseline telemetry known to be healthy. However, this can be time consuming and potentially error prone. Existing tools like monitors on error rate metrics can partially automate this manual work, but with significant risks of both false positive and false negative results, given the simplistic nature of manually defined monitors.

### BRIEF SUMMARY

The present disclosure describes a system for quickly detecting faulty software deployments, using a sequence of different analysis models executed at different time increments after the deployment. The analyses may include different machine learning models. Periodically, the system collects data on each deployment during the given period, and applies a set of labeling functions to generate non-binary classifications. The non-binary classifications are used to generate labels using weak supervision, and the labels are used for training one or more supervised machine learning models. The trained models may be used in the sequence of different analyses executed for future software deployments.

One aspect of the disclosure provides a system comprising memory; and one or more processors in communication with the memory and configured to: execute a plurality of models in sequence after deployment of a version of software, each of the models generating output indicating whether defects in the version of software were detected; generate, using a machine learning model, a set of strong labels based on the output of at least one of the plurality of models; and train, using the set of strong labels, at least one of the plurality of models to infer subsequent defects in deployment of subsequent versions of software. Executing the plurality of models may include executing a first model at a first time after the deployment, wherein first output generated by the first model indicates whether a first set of defects was detected; executing a second model, different than the first model, at a second time after the deployment, wherein second output generated by the second model indicates whether a second set of defects was detected; and executing a third model, different than the first model and the second model, at a third time after the deployment, wherein third output generated by the third model indicates whether a third set of defects was detected. The first model may receive observability data and detect whether previously unseen defect signatures are present within the observability data. The second model may be a machine learning model trained using supervised learning to function as a classifier to detect defects. The third model may include a plurality of statistical checks to determine whether the deployment caused an increase in defect rate of resources. Training at least one of the plurality of models may include training the second model. Generating the set of strong labels may include utilizing a weak supervision framework. In executing the weak supervision framework, the one or more processors may be configured to: generate a combined dataset comprising intermediary results from the third model with the first output from the first model; and apply a set of labelling functions to the combined dataset. Applying the set of labelling functions to the combined dataset may generate weak labels indicating whether the deployment is faulty, the deployment is not faulty, or if fault is uncertain. An output generated by applying the labelling functions to the combined dataset is input to a generative model to generate the strong labels.

Another aspect of the disclosure provides a method comprising: executing, with one or more processors, a plurality of models in sequence after deployment of a version of software, each of the models generating output indicating whether defects in the version of software were detected; generating, using a machine learning model, a set of strong labels based on the output of at least one of the plurality of models; and training, using the set of strong labels, at least one of the plurality of models to infer subsequent defects in deployment of subsequent versions of software. Executing the plurality of models may include: executing a first model at a first time after the deployment, wherein first output generated by the first model indicates whether a first set of defects was detected; executing a second model, different than the first model, at a second time after the deployment, wherein second output generated by the second model indicates whether a second set of defects was detected; and executing a third model, different than the first model and the second model, at a third time after the deployment, wherein third output generated by the third model indicates whether a third set of defects was detected. The first model may receive observability data and detects whether previously unseen defect signatures are present within the observability data. The second model may include a machine learning model trained using supervise learning to function as a classifier to detect defects. The third model may include a plurality of statistical checks to determine whether the deployment caused an increase in defect rate of resources. Training at least one of the plurality of models may include training the second model. Generating the set of strong labels may include utilizing a weak supervision framework. Executing the weak supervision framework may include: generating a combined dataset comprising intermediary results from the third model with the first output from the first model; and applying a set of labelling functions to the combined dataset. Applying the set of labelling functions to the combined dataset generates weak labels that may indicate whether the deployment is faulty, the deployment is not faulty, or if fault is uncertain. An output generated by applying the labelling functions to the combined dataset is input to a generative model to generate the strong labels.

Another aspect of the disclosure provides a non-transitory computer-readable medium storing instructions executable by one or more processors for performing a method of detecting faulty deployments, the method comprising executing a first model at a first time after the deployment, wherein first output generated by the first model indicates whether a first set of defects was detected; executing a second model, different than the first model, at a second time after the deployment, wherein second output generated by the second model indicates whether a second set of defects was detected; and executing a third model, different than the first model and the second model, at a third time after the deployment, wherein third output generated by the third model indicates whether a third set of defects was detected.

### BRIEF DESCRIPTION OF THE DRAWINGS

FIG. 1 is a block diagram illustrating an example system for detecting faulty deployments according to aspects of the disclosure.

FIG. 2 illustrates an example workflow of a weak supervision framework in the example system of FIG. 1.

FIG. 3 is a schematic diagram illustrating an example pipeline according to aspects of the disclosure.

FIG. 4 is a block diagram illustrating an example system according to aspects of the disclosure.

FIG. 5 is a block diagram illustrating an example system according to aspects of the disclosure.

FIG. 6 is a flow diagram illustrating an example method according to aspects of the disclosure.

### DETAILED DESCRIPTION

The system provides a framework for quickly detecting faulty software deployments, using a sequence of different analysis models executed at different time increments after the deployment. The analyses may include different machine learning models. The system collects data on each deployment during a given period, and applies a set of labeling functions to generate non-binary classifications. The collection of data may be continuous or periodic, with analysis of the collected data being performed at points in time. The set of labeling functions may be a mix of labeling functions with indirect sign, such that the labeling functions may be imperfectly correlated with variables. Examples of this may include version roll-backs, short-lived versions, paging monitors, faulty deployments for the same version in other data centers, whether an increase in defect rate can be correlated with an upstream service having a defect (and therefore not caused by a deployment), etc. The non-binary classifications are used to generate labels using weak supervision, and the labels are used for training one or more supervised machine learning models. For example, the labeling functions may output a score value between 0 and 1, which is then converted into two to three classes (unknown, faulty and/or not faulty). The trained models may be used in the sequence of different analyses executed for future software deployments.

The sequence of different analysis models may be executed at different periods in time after each deployment, with input data that spans different durations of time. For example, a first model may be executed shortly after deployment (e.g., after 2, 10, 20, and 50 minutes), while a second model is executed at a later point in time (e.g., after 10, 20, and 60 minutes), and a third model is executed even later (e.g., after 60 and 180 minutes). The amount of data input at each progressive point in time may span a longer duration and may include some or all of the data from the previous point in time. For example, input to the first model at 10 minutes may include some or all of the data input to the model at 2 minutes. In other examples, the data input to the second model may include some or all of the data input to the first model at previous points in time, and/or the data input to the third model may include some or all of the data input to the first and second models. While three models are used in this example, other examples may include additional or fewer models. Moreover, the spans of time at which the models are executed are merely examples and can be modified.

In some examples, the first model is an algorithm to determine if the deployment has introduced any new “defect signatures” not previously found in the observability data. In other words, the algorithm detects whether the newly deployed version of software introduced previously unseen defects. The defects may include, for example, errors, warnings, anomalies, delays, particular information, etc. The defect signatures may be defined by, for example, resource name, operation name, defect type, HTTP status code, etc. A first query to an event platform may retrieve trace events for the new version, and a second query retrieves events that happened in previous deployments. Based on a comparison of the results retrieved by each query, a set of new defect signatures may be extracted. If a new defect is detected, the user is alerted.

The second model may be a supervised machine learning model that is executed to determine if the new version of software that was deployed has caused an increase in error rate of any of its resources (e.g. API endpoints). The supervised machine learning model may function as a trained classifier that infers what an output of a later job will be, using input features from a shorter time period. If the model classifies the version as faulty, the user is alerted.

The third model may evaluate a number of statistical checks to determine if the new version of software that was deployed has caused an increase in the error rate of any of its resources. If the statistical checks indicate an increase, the user is alerted.

The weak supervision framework may be used to label data for training the supervised machine learning model (second model above). The output of the statistical checks (third model) may be saved to a data store for use in the weak supervision framework. In particular, the output of the statistical checks may be combined with the output of the signature detection algorithm (first model) and signals or additional data for the deployment, such as whether the software was rolled back to an earlier version. Other example signals can include, but are not limited to, short-lived versions, correlation with high quality user defined monitors, classifications of whether the defect is deployment related or not, correlation with upstream services having issues, the same version being detected as faulty in another datacenter, the version being associated with a significant increase in latency, or any of a variety of other signals. In the weak supervision model, a set of labelling functions is applied to the combined dataset. The labelling functions provide a non-binary output. As an example, the labeling functions may output a score, which may be converted to a {1, 0, or −1}, where 1 represents a faulty deployment, 0 represents a non-faulty deployment, and −1 represents uncertain cases. Such conversion may be performed by defining cutting points. By way of example, where the labeling function outputs scores between 0 and 1, a score lower than 0.35 may convert to “0” to represent a non-faulty deployment, a score above 0.65 may convert to a “1” to represent a faulty deployment, and anything in between 0.35-0.65 may convert to a “−1” to represent uncertainty. In other examples, the labeling functions may output scores in a different range, and/or different cutting points may be defined. Moreover, the output scores may be converted to a different number of categories, such as two, four, etc. Some labeling functions may be used only to find faulty deployments, and convert scores to {1, −1}, other functions may be used only to find healthy deployments, and convert scores to {0, −1}. Such output is used to generate strong labels using a generative model.

The strong labels generated in the weak supervision framework are used to train one or more of the models executed after deployment to detect faults. For example, the second and third models may include two random forest models-one using features detected after a first span of time (e.g., 10 minutes after deployment) and a second using features detected after a second span of time (e.g., 20 minutes after deployment). The random forest models may be trained based on the output from the weak supervision framework. The trained random forest models may then be utilized to detect defects in subsequent deployments. While in some of the examples described above and herein the first model is a rules-based model and the second model is a supervised learning model, in other examples different types of models may be used for different stages of detection of defects. For example, the model executed at the first stage may be a supervised learning model trained to detect a first type of defect, and the model executed at the second stage may be also be a supervised learning model but trained to detect a second type of defect different than the first type of defect. In other examples, other types of machine learning models (e.g., semi-supervised, unsupervised, reinforcement, etc.) may be used for any of the stages of defect detection.

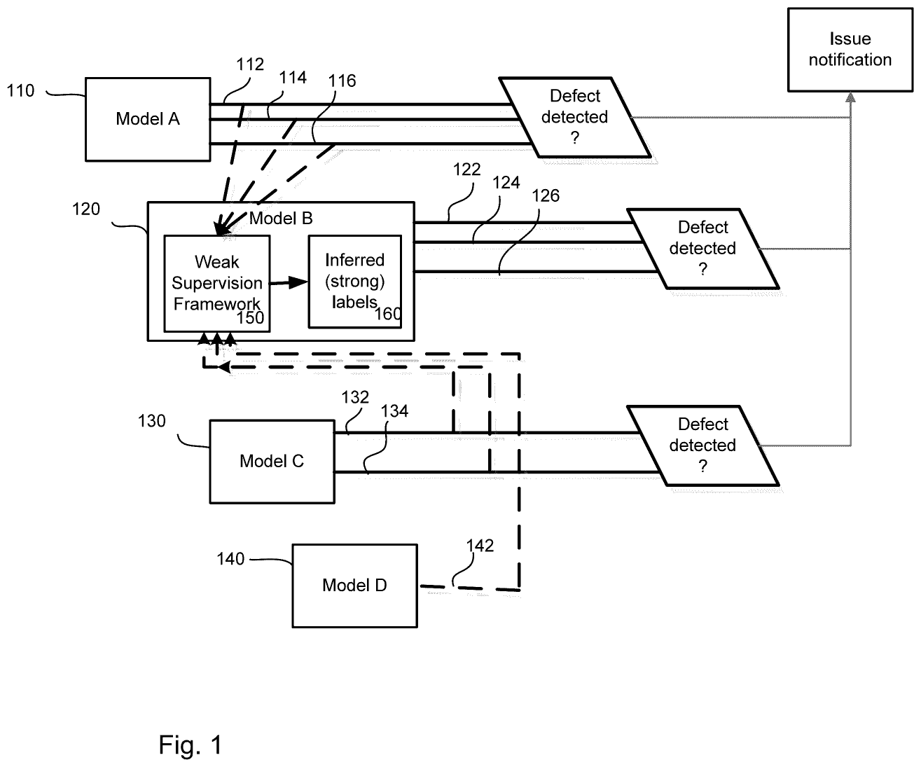

FIG. 1 illustrates an example system including a plurality of models, that may be executed at different intervals after deployments to detect different types of defects. The outputs of such models may be utilized in a weak supervision framework to generate strong labels. The strong labels may be used to train one or more of the plurality of models to detect defects in future deployments. In this regard, defects in deployed versions of software can be detected more quickly after deployment and may use less data as compared to traditional detection techniques.

A deployment may be characterized as defective if it is correlated with an increase in defects, such as an increase in error rate, latency, etc. The deployment may be correlated with an increase in defects by determining whether the deployment exhibits any of a variety of attributes, such as significant increase in defect rate, high defect count, a correlation of the increase in defect rate with a timing of the deployment, a persisted defect rate increase, time delays, etc. Other attributes that may be correlated with defect may include anomalies, such as anomalies in CPU usage, memory usage, disk usage, number of retries, trace topology (e.g., unexpected request paths through services and resources), logs (e.g. increase in warning logs), networking (e.g., a number of connections opened), real user monitoring, business key performance indicators (e.g., abandoned e-commerce carts, drop in completed registrations, or the like), etc.

To determine whether an increase in defect rate is significant, a measured defect rate may be compared to the rate of defects in a previous version. For example, it can be determined if a number of detected defects, as compared to the previous version, meets or exceeds a threshold. The defect rate may be high in itself, such as if the defect rate exceeds another threshold without considering the relative error rate of previous versions.

The timing of the detected defects may be compared to the timing of the deployment to confirm whether the defects are related to the deployment, or if they are caused by another event. In some cases, defects may resolve quickly, such as if the defects are related to the deployment process itself as opposed to the new version of software. Accordingly, it can be determined whether the defects persist over time, in which case the persistent defects may signal a faulty deployment.

As shown in FIG. 1, a plurality of models 110-140 are executed using data from the deployed version of software. While four models 110-140 are shown, it should be understood that additional or fewer models may be utilized. Each of the plurality of models may be different. For example, the models may detect different types of attributes that may indicate fault. As another example, the models may have different parameter values but the same model architecture, such as if multiple models are random forest models but trained on different data, for example using error and requests time series at different points after the deployment. In other examples, the models may have different architectures and different parameter values. As an example, one model may be a random forest model while another is a Bayesian architecture. According to one example, a first model may check for different error signatures, while a second model executes a supervised learning model to determine if the deployment caused an increase in error rate of any of its resources, and a third model executes statistical analyses to determine if the deployment caused an increase in error rate of any of its resources.

After each deployment, analysis is conducted by one or more of the models 110-140 at different timestamps. At each timestamp, progressively more data becomes available regarding the deployment. The data may be observability data, such as physical or electrical measurements. The data may be obtained through telemetry or other mechanisms, and may be obtained remotely or on-site.

According to one example, first model 110 determines whether any new defect signatures are present in the data that were not previously found within the data. The first model 110 may be executed at timestamps shortly following deployment. By way of example, the first model 110 may generate a first output 112 two minutes after deployment, a second output 114 ten minutes after deployment, a third output 116 thirty minutes after deployment, etc. While three outputs 112, 114, 116 are shown, it should be understood that the first model 110 may be executed at additional timestamps to generate additional outputs, or at fewer timestamps to generate fewer outputs. Moreover, the timing of execution at two minutes, ten minutes, thirty minutes is merely one example and can be varied. By way of example, the timing of execution may be at two minutes, ten minutes, twenty minutes, and fifty minutes. If new defect signatures are detected during any of the executions of the first model 110, a notification or alert may be generated. In this regard, the notification may alert a user or technician of the fault promptly after deployment such that the defects can be fixed promptly.

Defect signatures may be defined by, for example, resource name, operation name, defect type, HTTP status code, or other parameters. In detecting new defect signatures, data may be fetched for the newly deployed version and for previous versions. With respect to the data for previous versions, it may be limited to defect types that were seen in the newly deployed version, or to resources that had defects in the newly deployed version. The data for the previous version may serve as baseline data for determining whether defect signatures in the newly deployed version are new. Defect signatures are extracted from both the data for the newly deployed version and the baseline data and compared. If a signature is present in both sets, it can be discarded under the assumption that it was not a defect introduced by the newly deployed version. For signatures that are only present in the dataset for the newly deployed version, but not the baseline dataset, it may be determined if the defect signatures have additional attributes, such as if they are only present on new or sparse resources, or if they persist over time. Based on such additional attributes, the new defect signatures may generate an alert to the user or technician.

According to some examples, second model 120 may be executed to determine whether the newly deployed version has caused an increase in defect rate of any of its resources, such as application programming interface (API) endpoints. The second model 120 may be, for example, a supervised learning model including a weak supervision framework 150 which receives input from the models 110, 130, 140 and generates strong labels 160. The second model 120 may be executed at, for example, ten minutes, twenty minutes, and thirty minutes to generate output 122, 124, 126, respectively. Similar to the first model 110, the second model 120 may be executed at additional or fewer timestamps after deployment, and the intervals at which the second model 120 is executed may be varied. For example, in some cases the timing of execution can be limited to ten minutes and twenty minutes. The second model 120 may use the strong labels 160 to determine whether a defect exists within the deployment, and if so to generate a notification. If it is determined by the second model 120 that the newly deployed version has caused an increase in defect rate, for example if the strong labels indicate a defect, a notification may be generated for a user or technician.

Third model 130 may be executed to evaluate statistical checks to determine if the newly deployed version caused an increase in defect rate of any of its resources. The statistical checks may include, for example, checks for relevance, significance, persistence, time correlation, etc. The third model 130 may be executed at timestamps that are later after deployment, as compared to the timing of execution of the first and second models 110, 120. For example, the third model 130 may be executed at one hour to generate first output 132 and again at several hours to generate second output 134. The third model 130 may be executed at additional or fewer executions, and the timing of the executions can vary from the present example. If the statistical checks indicate a defect, an alert or notification may be generated for the user or technician.

Fourth model 140 may be executed to determine whether any deployment within a time period was manually rolled back to an earlier version. According to some examples, the fourth model 140 may be executed once a day to generate output 142, but in other examples the fourth model 140 may be executed more or less frequently. The output of the fourth model 140 may be used as input to the weak supervision framework 150. Moreover, while not shown, additional models may also provide input to the weak supervision framework 150. Examples of such additional models may include models that monitor alerts, incidents called, etc.

In some examples, outputs from one or more of the models 110, 130, 140 are input to weak supervision framework 150. For example, the outputs 112, 114, 116 from the first model 110 and the outputs 132, 134 from the third model 130 may be input to the weak supervision framework 150, along with output 142 from the fourth model 140. In some examples, the input to the weak supervision framework 150 is combined into a single dataset of deployments for a given time period, such as a given day.

The weak supervision framework 150 is a framework for supervised learning in which authoritative labels are not available, but some set of partially unreliable or “weak” labels are. These “weak” labels may have limited coverage, such as being available for a subset of observations (e.g., they do not produce an output for every observation in the dataset), or limited accuracy (e.g., they are not guaranteed to be correct, and their defect rate is unknown). By directly modeling the coverage and accuracy of a large set of weak labels, a high-accuracy “strong” label for each observation can be observed. In the present example, rules from a rules-based model, e.g., third model 130, are combined with other information determined using other models.

In the weak supervision framework 150, a set of labeling functions is applied to the input dataset. The labelling functions provide a “weak label” for some observations, and the weak labels are used to infer a probabilistic or “strong” label. The weak labels generated by the labelling functions may non-binary, such as having values of 1, 0, or −1. For example, “1” may suggest that the deployment is faulty, while “0” suggests that the deployment is not faulty, and “−1” suggests that insufficient information is available. A generative model is used to generate a set of strong labels 160 indicating whether the deployment was faulty. The strong labels 160 are used to train models to predict labels. The trained models may include one or more of the models 110-140, such as first model 110 and second model 120, or other models. The trained models may be used for future deployments to detect faults promptly after deployment.

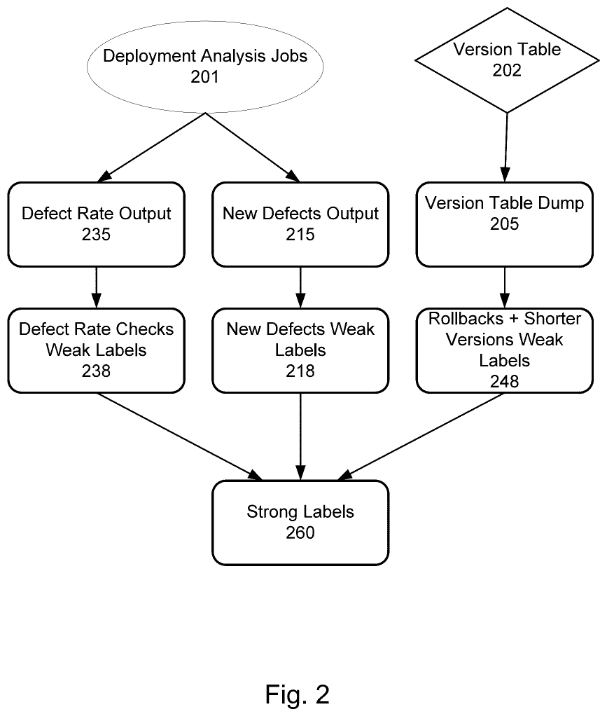

FIG. 2 illustrates an example flow relative to the weak supervision framework. Weak labels can be generated from deployment analysis jobs 201 and version table 202. In some examples, weak labels can be generated from monitor information, an output of a large language model (LLM) looking into error message, correlating outputs from models or other detected faulty changes, or any of a variety of other information.

The version table 202 may be a data structure maintained in a database to track data on all deployed code versions. Version table dump 205 may fetch data to an offline storage so that information about rollbacks, etc. can be extracted more easily. From the version table 202, information related to version rollbacks may be extracted and used to generate weak labels 248. The weak labels 248 may indicate the version is “faulty” if a resource is deployed sequentially, the defect rate increased after deployment, or if the version was rolled back. The weak labels 248 may indicate “unknown” in all other cases.

Deployment analysis jobs 201 may include at least one new error job to analyze error trace data of each service deployment to find new defect signatures appearing after the deployment. Because the appearance of a new defect signature does not necessarily mean the deployment is faulty, other conditions may be considered, such as if the new defect is transient or persistent. New defect signature output 215 may be used to generate weak labels 218, such as “faulty” or “unknown.” The new defect signature output 215 may include, for example, signals generated from the first model 110 of FIG. 1, such as the output 112, 114, 116. The weak labels 218 may indicate “faulty” if there is at least one new defect signature, and “unknown” in all other cases.

The deployment analysis jobs 201 may also include one or more jobs to analyze defect rate time series of each service deployment. Labelling functions for these jobs may be based on a score that is precomputed, similar to the statistical checks performed in the third model 130 of FIG. 1. For example, defect rate output 235 of FIG. 2 may include the outputs 132, 134 of the third model 130 of FIG. 1. The labelling functions may include an aggregated baseline comparison check, a baseline comparison check, a daily comparison check, a persistence check, a previous deployment check, a pre-deployment error spike check, a time correlation check, a transience check, etc. Each check may output a score that can indicate whether the deployment is faulty or not. The score may be compared with corresponding values to generate weak labels 238 indicating “faulty” or “not faulty” or “unknown.”

One or more of the sets of weak labels, including the defect check weak labels 238, new defects weak labels 8, and rollbacks and shorter versions weak labels 248, is used to generate strong labels 260. For example, the strong labels 260 may be generated by weighting agreements and/or disagreements among the sets of weak labels.

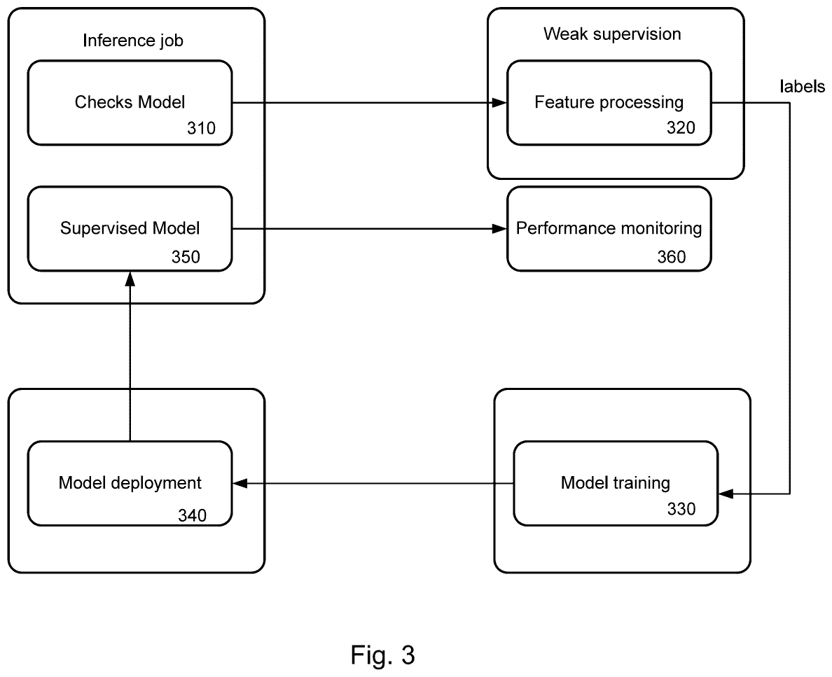

FIG. 3 illustrates an example pipeline for early detection of faulty version deployments. The pipeline introduces a supervised learning approach, which uses data from one or more unsupervised models as labels and detects faulty deployments within a short time after deployment.

Checks model 310 may be a basic unsupervised model for fault detection, such as a rules-based model. In feature processing 320, components of the check model 310 may be used, such as where each rules is considered a weak label. Moreover, the rules may be supplemented with external information about the deployment, such as whether it was subsequently rolled back to a previous version, whether it was unusually short-lived, whether it coincided with any monitors firing, and so on. By aggregating this information using the weak supervision framework, higher-quality labels are obtained for model training 330. Model training 330 may include training one model or multiple different models to infer results of subsequent deployments at shorter timestamps after the deployment. The trained models are deployed (340) and executed with improved precision and recall. Supervised model 350 may include the trained one or multiple models, and is executed to promptly detect a variety of possible types of faults. At inference, each of the models (e.g., both checks model 310 and supervised model 350) can generate a notification to a user to alert the user of a detected defect. During performance monitoring 360, it may be determined whether the models generated correct output. For example, output of the checks model 310 and the supervised model 350 may be compared to the strong labels that were generated. According to some examples, portions of the pipeline may be performed using different platforms. For example, feature processing 320 may be performed using one computational platform, while model training 330 is performed using another. In other examples, portions of the pipeline may be performed using a same platform.

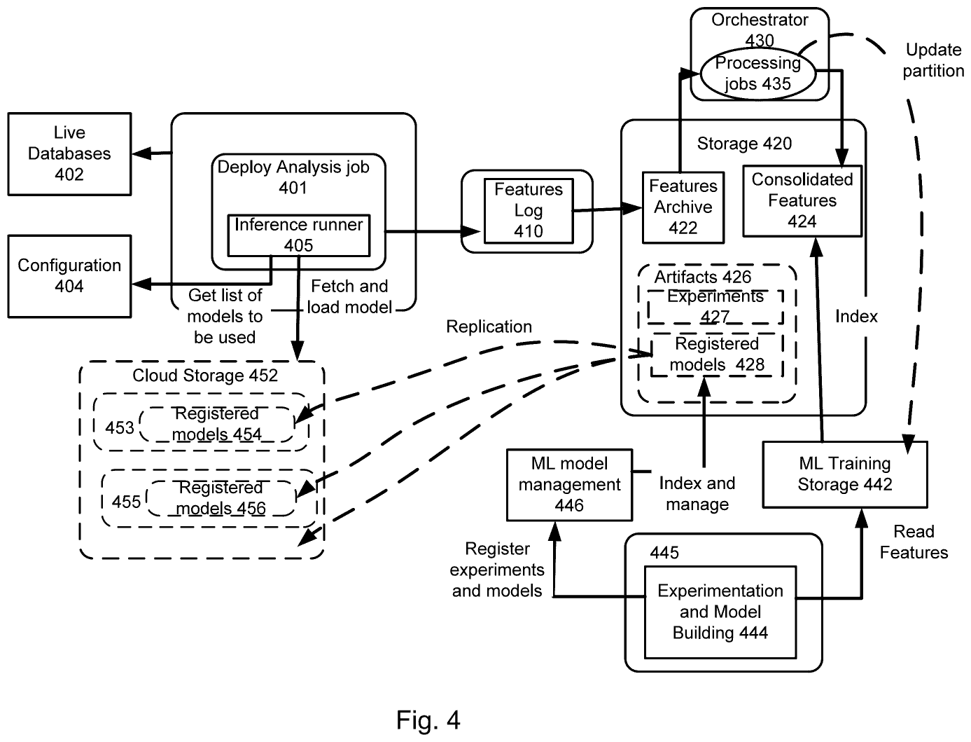

FIG. 4 illustrates a more detailed example of the pipeline, including how the plurality of models are generated, stored, and utilized in detecting the defects in the deployment.

According to some examples, building and training the models that will be executed for fault detection may be performed in a different environment than execution of the model. For example, as shown in FIG. 4, training the model may be performed in experimentation and model building platform 444. To train the supervised model to be used for early detection, in some examples a training notebook 445 leverages pre-computed features to create a wrapper that contains two components: a feature processor and a classifier. In other examples, the training notebook 445 can be omitted, and the operations instead performed by other components, such as the orchestrator 430. The feature processor processes the raw features into features that will be used by the classifier. This includes selecting features, handling null and infinite values and one-hot encoding categorical values. The classifier infers the output using the processed features. This can include several components, such as feature selection, scaling, classifier, etc. The wrapper may use a specific threshold to allow the right balance of precision/recall.

Hyperparameter tuning may be performed using random search based on a custom cross validation scheme. The cross-validation enforces temporality by only using past inferences to infer future ones. This may be done by dividing the examples in m+k buckets, where m is the minimum number of parts for training and k is the number of folds. Each fold is then defined by using m+i buckets for training and the i+1 th for testing.

According to some examples, experiments may be tracked such as by storing each training run in ML training storage 442 for the same experiment. Tags may be used to differentiate between different deployment analysis models. Such tags may identify a type of deployment analysis job, a computing environment, a deployment analysis project, filters used for training, trigger delays for features, etc. For each run, different information may be stored in ML model management unit 446. Such information may include, for example, the model wrapper that will be used at inference which also contains the raw classification model, parameters used for training the models (e.g., classification parameters, training data start and end dates, number of features, etc.), metrics computed using cross validation, and artifacts summarizing the performance of the model overall and across different pivots.

Once the prototyping phase is done resulting in a trained model, artifacts 426 can be stored, such as in storage 420, and published for availability in other computing environments. The artifacts 426 may include the experiments 427 and the trained model stored as registered model 428. Storing the trained model as a registered model may include packaging the model, registering the model with other computing platforms, and replicating the artifacts 426 to other environments, such as cloud storage 452. In other examples, automated retraining of the model may be performed, and version control may be added to the code training the model. In such examples, the ML training storage 442 contains only registered models trained using version controlled code run in the orchestrator 430. In further examples, training code may be version controlled in the orchestrator 430, but may be triggered manually.

According to some examples, feature processing may be packaged into the model artifacts 426 stored in storage 420 and then served at inference. For example, an object may be defined such that the object is used at input by the model during both training and inference. In this regard, input features for the models are consistent between training and inference, despite whether training and inference are performed in different computing environments.

Models may be tracked and indexed by the ML model management platform 446, and the registered models 428 stored in storage 420 as artifacts 426. These artifacts can be replicated to different datacenters 453, 455 as registered models 454, 456, respectively. While two datacenters 453, 455 are illustrated in cloud storage 452, it should be understood that any number of datacenters may be included, in one or more regions. The replicated models 454, 456 can be fetched from live services, such as inference runner 405.

In executing the models, the inference runner 405 may consult configuration library 404 to determine which models should be used to detect faults in a newly deployed version of software. For example, such models may include the models 110-140 described in connection with FIG. 1. The models may be fetched from cloud storage 452 and loaded. Deployment analysis job 401 is executed using telemetry or observability data from live databases 402 in which the new versions have been deployed, inputting the data from the live databases 402 as inference data. Feature logs 410 are generated based on execution of the models, the feature logs 410 indicating properties or characteristics of the live data. In some examples, such features may be stored in features archive 422. Processing jobs 435 within orchestrator 430 may be executed using the features archive 422 to create labels, etc. For example, the processing jobs 435 may include labelling functions, as described above in connection with FIG. 2. The output of such processing may be stored as consolidated features 424, and also used to update partitions of data stored for training the machine learning models and used as input to the weak supervision model.

While FIG. 4 illustrates training and execution of the models as being performed in different computing environments, in other examples the training and execution of the models may be performed in the same environment. For example, a faulty deployment detection system can receive the inference data and/or training data as part of a call to an application programming interface (API) exposing the faulty deployment detection system to one or more computing devices. Inference data and/or training data can also be provided to the faulty deployment detection system through a storage medium, such as remote storage connected to the one or more computing devices over a network. Inference data and/or training data can further be provided as input through a user interface on a client computing device coupled to the faulty deployment detection system.

The inference data can include data associated with execution of a newly deployed version of software in a live database. The inference data can include, for example, telemetry, observability data, event information, metadata, timestamps, device identifiers, etc.

The training data can correspond to an artificial intelligence (AI) or machine learning task for detecting faults in newly deployed versions of software. The training data can be split into a training set, a validation set, and/or a testing set. An example training/validation/testing split can be an 80/10/10 split, although any other split may be possible. The training data can be in any form suitable for training a model, according to one of a variety of different learning techniques. Learning techniques for training a model can include supervised learning, unsupervised learning, and semi-supervised learning techniques. For example, the training data can include multiple training examples that can be received as input by a model. The training examples can be labeled with a desired output for the model when processing the labeled training examples. The label and the model output can be evaluated through a loss function to determine a defect, which can be backpropagated through the model to update weights for the model. For example, if the machine learning task is a classification task, the training examples can be images labeled with one or more classes categorizing subjects depicted in the images. As another example, a supervised learning technique can be applied to calculate a defect between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

From the inference data and/or training data, the faulty deployment detection system can be configured to generate output data including one or more results related to detected anomalies or potential faults. As examples, the output data can be any kind of score, classification, or regression output based on the input data. Correspondingly, the AI or machine learning task can be a scoring, classification, and/or regression task for predicting some output given some input. As an example, the faulty deployment detection system can be configured to send the output data for display on a client or user display. As another example, the faulty deployment detection system can be configured to provide the output data as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices.

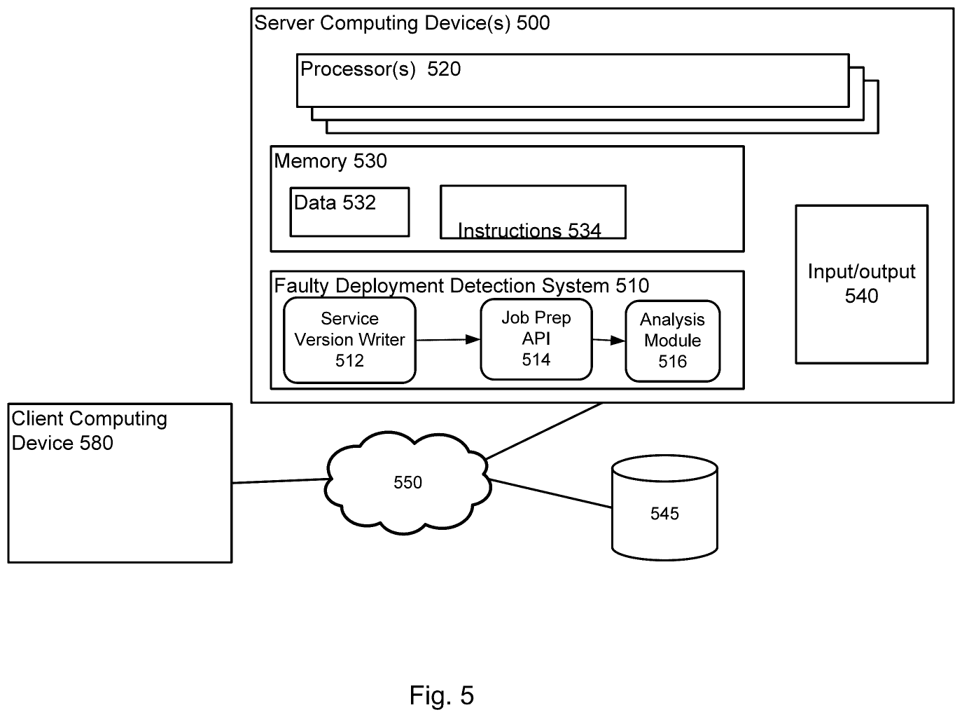

FIG. 5 depicts a block diagram of an example environment for implementing a faulty deployment detection system 510. The faulty deployment detection system 510 can be implemented on one or more devices having one or more processors in one or more locations, such as in server computing device 500. Client computing device 580 and the server computing device 500 can be communicatively coupled to one or more storage devices 545 over a network 550. The storage devices 545 can be a combination of volatile and non-volatile memory and can be at the same or different physical locations than the computing devices. For example, the storage devices 545 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 500 can include one or more processors 520, memory 530, and input/output 540. The memory 530 can store information accessible by the processors 520, including instructions 534 that can be executed by the processors 520. The memory 530 can also include data 532 that can be retrieved, manipulated, or stored by the processors 520. The memory 530 can be a type of non-transitory computer readable medium capable of storing information accessible by the processors, such as volatile and non-volatile memory. The processors can include one or more central processing units (CPUs), graphic processing units (GPUs), field-programmable gate arrays (FPGAs), and/or application-specific integrated circuits (ASICs), such as tensor processing units (TPUs).

The instructions 534 can include one or more instructions that, when executed by the processors 520, cause the one or more processors 520 to perform actions defined by the instructions 534. The instructions 534 can be stored in object code format for direct processing by the processors 520, or in other formats including interpretable scripts or collections of independent source code modules that are interpreted on demand or compiled in advance. The instructions 534 can include instructions for implementing a faulty deployment detection system, such as described above. The faulty deployment detection system can be executed using the processors 520, and/or using other processors remotely located from the server computing device 500.

The data 532 can be retrieved, stored, or modified by the processors 520 in accordance with the instructions 534. The data 532 can be stored in computer registers, in a relational or non-relational database as a table having a plurality of different fields and records, or as JSON, YAML, proto, or XML documents. The data 532 can also be formatted in a computer-readable format such as, but not limited to, binary values, ASCII, or Unicode. Moreover, the data 532 can include information sufficient to identify relevant information, such as numbers, descriptive text, proprietary codes, pointers, references to data stored in other memories, including other network locations, or information that is used by a function to calculate relevant data.

The client computing device 580 can also be configured similarly to the server computing device 500, with one or more processors, memory, instructions, and data. The client computing device 580 can also include a user input and a user output. The user input can include any appropriate mechanism or technique for receiving input from a user, such as keyboard, mouse, mechanical actuators, soft actuators, touchscreens, microphones, and sensors.

The server computing device 500 can be configured to transmit data to the client computing device 580, and the client computing device 580 can be configured to display at least a portion of the received data on a display implemented as part of the user output. The user output can also be used for displaying an interface between the client computing device and the server computing device. The user output can alternatively or additionally include one or more speakers, transducers or other audio outputs, a haptic interface or other tactile feedback that provides non-visual and non-audible information to the platform user of the client computing device.

Although FIG. 5 illustrates the processors and the memories as being within the computing devices, components described herein can include multiple processors and memories that can operate in different physical locations and not within the same computing device. For example, some of the instructions and the data can be stored on a removable SD card and others within a read-only computer chip. Some or all of the instructions and data can be stored in a location physically remote from, yet still accessible by, the processors. Similarly, the processors can include a collection of processors that can perform concurrent and/or sequential operation. The computing devices can each include one or more internal clocks providing timing information, which can be used for time measurement for operations and programs run by the computing devices.

The server computing device can be connected over the network to a data center housing any number of hardware accelerators. The data center can be one of multiple data centers or other facilities in which various types of computing devices, such as hardware accelerators, are located. Computing resources housed in the data center can be specified for deploying models related to detecting faulty deployments as described herein.

The server computing device can be configured to receive requests to process data from the client computing device on computing resources in the data center. For example, the environment can be part of a computing platform configured to provide a variety of services to users, through various user interfaces and/or application programming interfaces (APIs) exposing the platform services. The variety of services can include detecting faulty software deployments. The client computing device can transmit input data associated with execution of recently deployed versions of software. For example, the input can include observability data, telemetry, etc. The faulty deployment detection system 510 can receive the input data, and in response, generate output data such as a notification whether faults are detected. In some examples, the notification can include details as to the type of fault detected, timing, affected resources, and other information related to the fault.

The faulty deployment detection system 510 may further include a service version writer 512, a job preparation API 514, and an analysis module 416. The service version writer 512 detects deployed services. For example, deployed services can be detected using tags. For example, performance monitoring data (e.g., key performance indicators, number of requests, number of errors, etc.) may be tagged to facilitate manipulation, such as sorting, searching, etc., of the data in meaningful ways. A service version tag that is seen for the first time may indicate a deployment. The service version writer 512 submits jobs at predetermined intervals after deployment to the job preparation API 514. The job preparation API 514 prepares jobs for analysis, and performs basic screening of jobs. [Inventors—what is entailed in (1) preparing jobs for analysis, and (2) basic screening of jobs?] The job preparation API 514 enqueues jobs that pass the screening for analysis by the analysis module 516. The analysis module 516 analyzes the newly deployed version to determine whether it is faulty or healthy. If it is faulty, an event may be emitted and/or a notification may be emitted. The results of the analysis may be stored, for example, in database 545.

As other examples of potential services provided by a platform implementing the environment, the server computing device can maintain a variety of models in accordance with different constraints available at the data center. For example, the server computing device can maintain different families for deploying models on various types of TPUs and/or GPUs housed in the data center or otherwise available for processing.

The devices and the data center can be capable of direct and indirect communication over the network. For example, using a network socket, the client computing device can connect to a service operating in the data center through an Internet protocol. The devices can set up listening sockets that may accept an initiating connection for sending and receiving information. The network itself can include various configurations and protocols including the Internet, World Wide Web, intranets, virtual private networks, wide area networks, local networks, and private networks using communication protocols proprietary to one or more companies. The network can support a variety of short-and long-range connections. The short-and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network, in addition or alternatively, can also support wired connections between the devices and the data center, including over various types of Ethernet connection.

Although a single server computing device, client computing device, and data center are shown in FIG. 5, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing optimization models, and any combination thereof.

Although FIG. 5 functionally illustrates the processor, memory, and other elements as being within the same block, the processor, computer, computing device, or memory can actually comprise multiple processors, computers, computing devices, or memories that may or may not be stored within the same physical housing. Accordingly, references to a processor, computer, computing device, or memory will be understood to include references to a collection of processors, computers, computing devices, or memories that may or may not operate in parallel. Yet further, although some functions described below are indicated as taking place on a single computing device having a single processor, various aspects of the subject matter described herein can be implemented by a plurality of computing devices, for example, in the “cloud.” Similarly, memory components at different locations may store different portions of instructions 234 and collectively form a medium for storing the instructions. Various operations described herein as being performed by a computing device may be performed by a virtual machine. By way of example, instructions 234 may be specific to a first type of server, but the relevant operations may be performed by a second type of server running a hypervisor that emulates the first type of server. The operations may also be performed by a container, e.g., a computing environment that does not rely on an operating system tied to specific types of hardware.

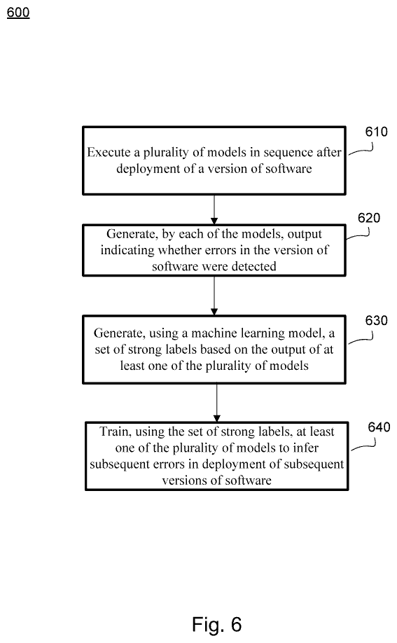

FIG. 6 illustrates an example method 600 of detecting faulty deployments using a weak supervision framework. While operations are described in a particular order, it should be understood that operations may be performed in a different order and/or some operations may be performed simultaneously or in parallel. Moreover, operations can be added or omitted.

In block 610, a plurality of models are executed in sequence after deployment of a version of software. Each of the plurality of models may be different. For example, the models may have different parameter values but the same model architecture. As an example, multiple of the models may be random forest models, but may use different values. In other examples, the models may have different architectures and different values. As an example, one model may be a random forest model while another is a Bayesian architecture. According to one example, a first model may check for different defect signatures, while a second model executes a supervised learning model to determine if the deployment caused an increase in defect rate of any of its resources, and a third model executes statistical analyses to determine if the deployment caused an increase in defect rate of any of its resources.

In block 620, each of the models generates a respective output indicating whether defects in the version of software were detected. The models may be executed at different times. For example, a first model may be executed at a first set of intervals after deployment, such as 2 minutes, 10 minutes, 20 minutes, etc. A second model may be executed at a second set of intervals after deployment, such as 10 minutes and 20 minutes. A third model may be executed at a third set of intervals after deployment, such as 60 minutes and 180 minutes.

In block 630, a machine learning model generates a set of strong labels based on the output of at least one of the plurality of models. This machine learning model may be, for example, a weak supervision framework.

In block 640, the set of strong labels is used to train at least one of the plurality of models to detect defective deployments of subsequent versions of software.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed on it software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as static or dynamic computational graph frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a stand alone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components, or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising:
memory; and
one or more processors in communication with the memory and configured to:
execute a plurality of models in sequence after deployment of a version of software, each of the models generating output indicating whether defects in the version of software were detected;
generate, using a machine learning model, a set of strong labels based on the output of at least one of the plurality of models; and
train, using the set of strong labels, at least one of the plurality of models to infer subsequent defects in deployment of subsequent versions of software.

2. The system of claim 1, wherein executing the plurality of models comprises:
executing a first model at a first time after the deployment, wherein first output generated by the first model indicates whether a first set of defects was detected;
executing a second model, different than the first model, at a second time after the deployment, wherein second output generated by the second model indicates whether a second set of defects was detected; and
executing a third model, different than the first model and the second model, at a third time after the deployment, wherein third output generated by the third model indicates whether a third set of defects was detected.

3. The system of claim 2, wherein the first model receives observability data and detects whether previously unseen defect signatures are present within the observability data.

4. The system of claim 2, wherein the second model comprises a machine learning model trained using supervised learning to function as a classifier to detect defects.

5. The system of claim 2, wherein the third model comprises a plurality of statistical checks to determine whether the deployment caused an increase in defect rate of resources.

6. The system of claim 2, wherein training at least one of the plurality of models comprises training the second model.

7. The system of claim 2, wherein generating the set of strong labels comprises utilizing a weak supervision framework.

8. The system of claim 7, wherein in executing the weak supervision framework, the one or more processors are configured to:
generate a combined dataset comprising intermediary results from the third model with the first output from the first model; and
apply a set of labelling functions to the combined dataset.

9. The system of claim 8, wherein applying the set of labelling functions to the combined dataset generates weak labels indicating whether the deployment is faulty, the deployment is not faulty, or if fault is uncertain.

10. The system of claim 7, wherein an output generated by applying the labelling functions to the combined dataset is input to a generative model to generate the strong labels.

11. A method comprising:
executing, with one or more processors, a plurality of models in sequence after deployment of a version of software, each of the models generating output indicating whether defects in the version of software were detected;
generating, using a machine learning model, a set of strong labels based on the output of at least one of the plurality of models; and
training, using the set of strong labels, at least one of the plurality of models to infer subsequent defects in deployment of subsequent versions of software.

12. The method of claim 11, wherein executing the plurality of models comprises:
executing a first model at a first time after the deployment, wherein first output generated by the first model indicates whether a first set of defects was detected;
executing a second model, different than the first model, at a second time after the deployment, wherein second output generated by the second model indicates whether a second set of defects was detected; and
executing a third model, different than the first model and the second model, at a third time after the deployment, wherein third output generated by the third model indicates whether a third set of defects was detected.

13. The method of claim 12, wherein the first model receives observability data and detects whether previously unseen defect signatures are present within the observability data.

14. The method of claim 12, wherein the second model comprises a machine learning model trained using supervise learning to function as a classifier to detect defects.

15. The method of claim 12, wherein the third model comprises a plurality of statistical checks to determine whether the deployment caused an increase in defect rate of resources.

16. The method of claim 12, wherein training at least one of the plurality of models comprises training the second model.

17. The method of claim 12, wherein generating the set of strong labels comprises utilizing a weak supervision framework.

18. The method of claim 17, wherein executing the weak supervision framework comprises:
generating a combined dataset comprising intermediary results from the third model with the first output from the first model; and
applying a set of labelling functions to the combined dataset.

19. The method of claim 18, wherein applying the set of labelling functions to the combined dataset generates weak labels indicating whether the deployment is faulty, the deployment is not faulty, or if fault is uncertain.

20. The method of claim 17, wherein an output generated by applying the labelling functions to the combined dataset is input to a generative model to generate the strong labels.

21. A non-transitory computer-readable medium storing instructions executable by one or more processors for performing a method of detecting faulty deployments, the method comprising:
executing a first model at a first time after the deployment, wherein first output generated by the first model indicates whether a first set of defects was detected;
executing a second model, different than the first model, at a second time after the deployment, wherein second output generated by the second model indicates whether a second set of defects was detected; and
executing a third model, different than the first model and the second model, at a third time after the deployment, wherein third output generated by the third model indicates whether a third set of defects was detected.
